(19) United States
(12) Patent Application Publication
(10) Pub. No.: US 2005/0086430 A1
(43) Pub. Date: Apr. 21, 2005

(54) Method, system, and program for designating a storage group preference order

(75) Inventors: Stevan C. Allen, Morgan Hill, CA (US); Sanjay Shyam, Los Altos, CA (US); Victor Sheng-Jian Liang, San Jose, CA (US); Savur Anand Rao, San Jose, CA (US)

Correspondence Address: KONRAD RAYNES & VICTOR, LLP.;ATTN: IBM37, 315 SOUTH BEVERLY DRIVE, SUITE 210, BEVERLY HILLS, CA, 90212, US

(73) Assignee: International Business Machines Corporation

(21) Appl. No.: 10/687,948

(22) Filed: Oct. 17, 2003

(51) Int. Cl. G06F 12/00

(52) U.S. Cl. 711/114; 711/170

(57) ABSTRACT

Disclosed is a method, system, and program for storing data. A cluster is associated with a plurality of storage groups. A storage group preference order is designated for data sets associated with the cluster. When a request to store a data set for the cluster is received, one of the plurality of storage groups is selected using the storage group preference order.

### BACKGROUND OF THE INVENTION

1. Field of the Invention

The present invention is related to designating a storage group preference order.

2. Description of the Related Art

In some computer systems, users manually select storage devices on which a file is to be stored. Such manual selection of a storage device sometimes resulted in job failure due to a device being unavailable, for example, because the storage device was offline or was out of storage space. Additionally, manual selection of a storage device sometimes resulted in workload imbalance (i.e., some devices are over utilized by users and have contention, while other devices are under utilized).

Some prior art computer systems allow for automated storage device selection to avoid the problems associated with manual selection. That is, these prior art computer systems assign a group of storage devices (e.g., disks) as one entity from which storage space may be selected when data needs to be stored. This one entity is called a storage group and includes a collection of storage devices, such as disks. A single storage device may be selected from within the storage group to satisfy storage space allocation for a new file or file extend to another disk. Allocating storage space for a new file is also referred to as “file allocation.” The term “file extend” refers to storage of a file across more than one storage device. For example, a file may initially be stored on a first storage device. Then, the file may be updated, which increases the size of the file. Additionally, at the time the size of the file is increased, the first storage device may not have any storage space available for storing data. In this case, the storage of the file may need to be “extended” across two or more storage devices.

A storage group may contain devices of differing characteristics (e.g., available storage space, performance, features, etc.). In some prior art computer systems, a set of rules are implemented to facilitate automated selection of a storage device from a group of devices based on file requirements and preferences. The selection is made by selecting a storage device from a list of storage devices in a storage group.

U.S. Pat. No. 5,491,810 issued on Feb. 13, 1996 to Steve Allen describes a technique to automate storage device selection. U.S. Pat. No. 5,491,810 addressed the problem of having users manually select storage devices by allowing a data set to include a group of associated preference/requirement parameters.

When all storage devices within an assigned storage group become unavailable (e.g., out of space or offline), the file allocation or file extend may fail. To address this problem, it was possible to assign multiple storage groups to a new file allocation or file extend in order to increase the number of eligible storage devices on which a file could be stored. Prior art techniques merge the eligible storage devices from all assigned storage groups into one eligible storage group for storage device selection. The merging of multiple storage groups into one eliminates the differentiation of storage groups from the selection process.

For example, assume that a customer has defined three storage groups named Production, Finance, and Human Resources for file placement. In this example, a customer desires Production, Finance, and Human Resources files to be kept separate. A condition may occur in which all Human Resources storage devices run out of space, resulting in Human Resources job failures when creating new files or extending files. At the same time, the Finance storage group may have a large amount of available storage space. If the customer assigns both the Human Resources and Finance storage groups to a new Human Resources allocation, then both the Finance and Human Resources storage groups are treated equally. That is, a new Human Resources file may be placed in the Finance storage group even when there is available storage space in the Human Resources storage group.

In some prior art computer systems, a storage group could have a status of Enabled, Disabled, or Quiesce. The Enabled status indicated that data could be stored on the storage group. The Disabled status indicated that data could not be stored on the storage group. The Quiesce status was provided to indicate that a storage device within a storage group was to used as last resort when selecting a storage device. Although the Quiesce status was provided to drain work away from particular storage devices for maintenance, the Quiesce status is sometimes used to create “overflow/spill” storage groups. That is, when other storage devices in a storage group do not have available storage space, then the storage device with the Quiesce status is used to store data.

Additionally, a storage group may be designated as an “overflow” storage group to provide an overflow/spill storage group without using the Quiesce status.

Quiesce and Overflow each refer to a storage group status that spans multiple jobs that allocate files. In prior art computer systems, a storage group can not be both quiesced and enabled (e.g., there is no prior art technique to group Finance and Production storage groups together, where the Production group is quiesced for Finance allocations and the Finance group is quiesced for Production allocations). In particular, a storage group can not be both quiesced and enabled because in the event the allocations to, for example, the Production and Finance storage groups, happen simultaneously, both would see the same storage group status, again, because the prior art allows each storage group to have one status (enabled, quiesced) active at one time.

Therefore, there is a need in the art for improved storage group usage.

### SUMMARY OF THE INVENTION

Provided are a method, system, and program for storing data. A cluster is associated with a plurality of storage groups. A storage group preference order is designated for data sets associated with the cluster. When a request to store a data set for the cluster is received, one of the plurality of storage groups is selected using the storage group preference order.

The described implementations of the invention provide a method, system, and program for identifying preferences for storage group selection when one or more storage groups from a set of storage groups may be selected for storing a data set. In particular, a new storage group preference statement is provided for use in defining a storage group preference order.

### BRIEF DESCRIPTION OF THE DRAWINGS

Referring now to the drawings in which like reference numbers represent corresponding parts throughout:

FIG. 1 illustrates, in a block diagram, a computing environment in accordance with certain implementations of the invention.

FIG. 2 illustrates, in a block diagram, a storage group in accordance with certain implementations of the invention.

FIG. 3 illustrates logic for generation of a storage group preference policy in accordance with certain implementations of the invention.

FIG. 4 illustrates logic for automatically selecting a storage group in accordance with certain implementations of the invention.

FIG. 5 illustrates an architecture of computer systems that may be used in accordance with certain implementations of the invention.

### DETAILED DESCRIPTION

In the following description, reference is made to the accompanying drawings which form a part hereof and which illustrate several implementations of the present invention. It is understood that other implementations may be utilized and structural and operational changes may be made without departing from the scope of the present invention.

Implementations of the invention allocate new and growing files to multiple storage groups based on a storage group preference order associated with each storage group. For example, if there are three storage groups, Production, Finance, and Human Resources, to which data sets may be allocated, a storage group preference order is designated by, for example, a system administrator. A data set may be a file, a database, or other related portion of data. For example, if a data set for Human Resources is to be stored, the automated storage group selection process may select storage groups in the following order: Human Resources, Finance, Production. If a data set for Finance is to be stored, the automated storage group selection process may select storage groups in the following order: Finance, Production, Human Resources. If a data set for Production is to be stored, the automated storage group selection process may select storage groups in the following order: Production, Human Resources, Finance.

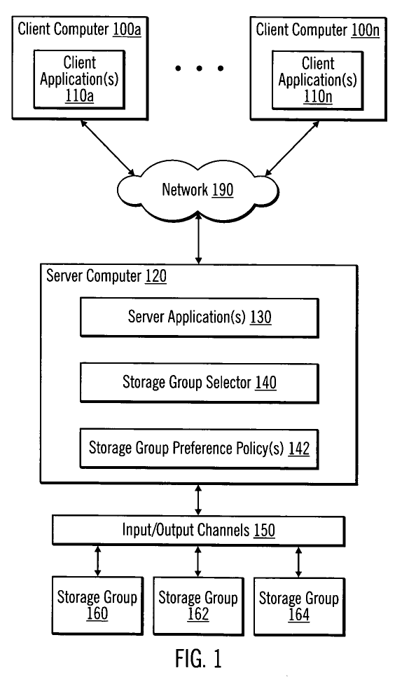

FIG. 1 illustrates, in a block diagram, a computing environment in accordance with certain implementations of the invention. Client computers 100a . . . 100n include one or more client applications 110a . . . 110n, respectively. The character suffixes of “a” and “n” and the ellipses (e.g., 100a . . . 100n) indicate that any number of referenced elements (e.g., client computers or client applications) may be included in the computing environment. Client computers 100a . . . 100n may comprise any type of computing device. Client computers 100a . . . 100n are connected to a server computer 120 via a network 190 such as a local area network (LAN), wide area network (WAN), or the Internet. The Internet is a world-wide collection of connected computer networks (i.e., a network of networks). The client applications 110a . . . 110n may access data managed by the server computer 120, may edit the data, and may store new data at the server computer 120.

The server computer 120 may comprise any type of computing device. The server computer 120 includes one or more server applications 130, a storage group selector 140, and one or more storage group preference policies 142. The server applications 130 may be any type of server applications. The storage group preference policy 142 includes one or more automation rules that indicate a storage group preference order for selecting storage groups. The storage group selector 140 automatically selects a storage group from a set of storage groups for storing a data set based on the storage group preference policy 142. The server computer 120 is connected via input/output channels 150 to storage groups 160, 162, and 164. The input/output channels 150 are communication paths between the server computer 120 and storage devices in the storage groups 160, 162, and 164. In certain implementations of the invention, a small computer system interface (SCSI) maybe used to attach storage devices within storage groups 160, 162, and 164 to the server computer 120.

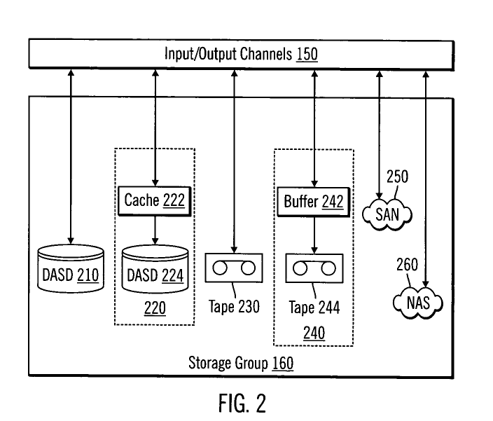

FIG. 2 illustrates, in a block diagram, a storage group 160 in accordance with certain implementations of the invention. Any type of storage device or sub group of storage devices (e.g., a Storage Area Network (SAN), Network Attached Storage (NAS), or other sub storage group) may be included in a storage group, and the storage devices illustrated in FIG. 2 are specified merely as examples. The storage group 160 is attached to input/output channels 150. Storage group 160 includes different types of storage devices. For example, storage group 160 includes medium and/or high performance Direct Access Storage Device (DASD) subsystem(s) 210, cached DASD subsystem(s) 220, tape subsystem(s) 230, buffered tape subsystem(s) 240, Storage Area Network (SAN) 250, and Network Attached Storage (NAS) 260. A cached DASD 220 subsystem includes cache 222 and DASD 224. A buffered tape subsystem includes a buffer 242 and a tape subsystem 242.

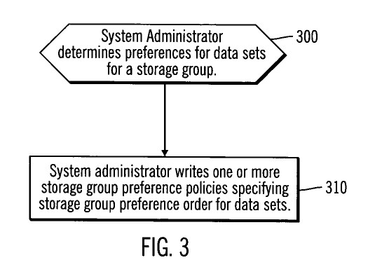

FIG. 3 illustrates logic for generation of a storage group preference policy 142 in accordance with certain implementations of the invention. Initially, an individual, such as a system administrator, determines storage group preferences for data sets for a storage group (block 300). Storage groups may be associated with any cluster (e.g., uses, functional teams, individuals, computer programs, or data sets with particular attributes), and the examples given herein are not meant to be exhaustive. For example, the term “storage group” refers to a group of storage devices designated for one or more particular uses (e.g., storing large data sets or small data sets), associated with one or more functional teams (e.g., a Finance department), associated with one or more computer programs, associated with one or more data sets having certain attributes, or associated with any combination of these (e.g., associated with a Finance department and a Finance computer program). For example, a Finance storage group may be designated primarily for storing Finance data sets. The system administrator may talk to individuals in Production, Finance, and Human Resources departments to make the determination of storage group preference order for data sets generated within the Production, Finance, and Human Resources departments.

In block 310, the system administrator generates one or more storage group preference policies 142, specifying storage group preference order for data sets. The storage group preference policy 142 may be generated using, for example, a system administration tool. One example of such a tool is an Interactive Storage Management Facility(ISMF) available from International Business Machines Corporation, and an ISMF tool is used in certain implementations of the invention.

Implementations of the invention provide a new storage group preference statement that is added to the storage group preference policy 142. The following is a sample format of automation rules for specifying a storage group preference order for a Finance data set:

If Finance Data Set

. . .
StorageGroup = (Finance, Human Resources, Production)
Preference Setting = On
. . .

In this example, the “If Finance Data Set” statement determines whether the data set is a Finance data set. Finance refers to a functional team, which is a type of cluster with which one or more storage groups are associated. The determination of whether a data set is associated with a particular cluster (e.g., particular uses, functional teams (such as Finance), computer programs, or data set attributes) may be made, based on one or more factors, such as, for example, the computer program that generated the data set (e.g., a Finance computer program generated the data set), the user who created the data set (e.g, the user is employed in the Finance department), or metadata in the data set (e.g., metadata may indicate that the Finance department is the owner of the data set).

The StorageGroup statement designates a list of eligible storage groups for a data set. In this example, the StorageGroup statement designates Finance, Human Resources, and Production as a list of eligible storage groups for storage of a Finance Data Set.

The Preference Setting statement is a new storage group preference statement provided by implementations of the invention, and the form of the statement may vary in various implementations of the invention. In certain implementations of the invention, the Preference Setting statement sets an indicator (e.g., a flag) to “on” to indicate that the order of storage groups listed in the StorageGroup statement is the storage group preference order. In certain alternative implementations of the invention, the Preference Setting may be preset to indicate that the order of storage groups listed in the StorageGroup statement is the storage group preference order (e.g., the Preference Setting is hard coded to “on”). The ellipses indicate that other statements may be included in the storage group preference policy 142. That is, each time an individual or computer program (e.g., in a Finance department) creates a new data set or extends an existing data set and stores the data set, the storage group selector 140 identifies a storage group to be used based on the storage group preference policy. In addition, in certain implementations of the invention, the preference order may represent a retry condition so that when the first storage group is selected but can not satisfy the request (e.g. not enough space), the next storage group is then selected (i.e., a retry is performed), and so on until all eligible storage groups are selected. If none of the eligible storage groups are able to satisfy the request, the data set allocation fails.

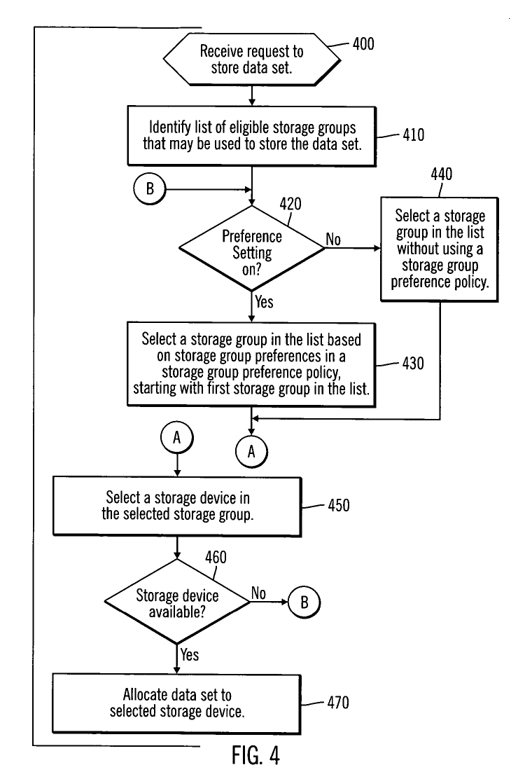

FIG. 4 illustrates logic for automatically selecting a storage group in accordance with certain implementations of the invention. Control begins at block 400 with the storage group selector 140 receiving a request to store a data set. The data set may be a newly created data set that is being stored for the first time or may be an existing data set that has increased in size. In block 410, the storage group selector 140 identifies a list of eligible storage groups in which the data set may be stored using the storage group preference policy 142 for the data set. In particular, the storage group selector 140 determines which cluster the data set is associated with, and finds automation rules for that cluster in the storage group preference policy 142. The automation rules specify a list of eligible storage groups for that data set.

In block 420, the storage group selector 140 determines whether the Preference Setting is on, indicating that the order of the storage groups in the StorageGroup statement is the preferred selection order. If the Preference Setting is on, processing continues to block 430, otherwise, processing continues to block 440. In block 430, the storage group selector 140 selects a storage group in the list into which the data set is to be stored based on the storage group preference order, starting with the first storage group in the list. In block 440, a storage group in the list is selected without using a storage group preference policy.

In block 450, a storage device is selected in the storage group. In block 460, it is determined whether the selected storage device is available (e.g., has available storage space and is on-line) for storing the data set. If so, processing continues to block 470, otherwise, processing loops back to block 420 and another storage group in the list is selected. In block 470, the data set is allocated to the selected storage device. In certain implementations of the invention, in block 460, multiple storage devices are selected, and in block 470, the data set is stored on one or more storage devices. In certain implementations of the invention, multiple storage groups may be selected for storing the data set, and the data set may be stored in one or more storage devices in each of the selected storage groups.

Thus, with the storage group preference policy 142, succeeding storage groups are utilized when the previously listed storage groups cannot satisfy an allocation. For example, the second storage group is utilized when the first storage group specified in a storage group preference order cannot satisfy the allocation, and the third storage group is utilized when the first and second storage groups specified in the storage group preference order cannot satisfy the allocation.

Unlike conventional systems that treat multiple eligible storage groups as one, implementations of the invention maintain storage group differentiation in the storage device selection process, with storage groups ordered by storage group preferences.

Additionally, implementations of the invention allow customers to assign backup storage groups so that the backup storage group will be utilized only when the primary storage group is unavailable or otherwise cannot satisfy an allocation.

Moreover, implementations of the invention overcome the problem of prior art computer systems in which a storage group can not be both quiesced and enabled by using a separate preference order for each storage group allocation.

Thus, implementations of the invention, use automation rules based on the storage group preference policy to determine a different storage group preference order for each data set allocation.

### Additional Implementation Details

The described techniques for designating a storage group preference order may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, storage networks (e.g., SAN or NAS), etc.). Code in the computer readable medium is accessed and executed by a processor. The code in which described embodiments are implemented may further be accessible through a transmission medium or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

The logic of FIGS. 3 and 4 describes specific operations occurring in a particular order. In alternative implementations, certain of the logic operations may be performed in a different order, modified or removed. Moreover, steps may be added to the above described logic and still conform to the described implementations. Further, operations described herein may occur sequentially or certain operations may be processed in parallel, or operations described as performed by a single process may be performed by distributed processes.

The illustrated logic of FIGS. 3 and 4 was described as being implemented in software. The logic may be implemented in hardware or in programmable and non-programmable gate array logic.

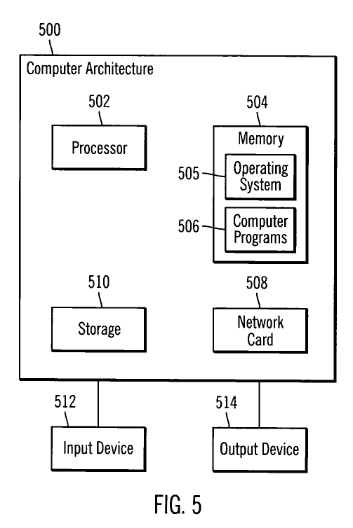

FIG. 5 illustrates an architecture of computer systems 100a . . . 100n and 120 that may be used in accordance with certain implementations of the invention. The computer architecture 500 may implement a processor 502 (e.g., a microprocessor), a memory 504 (e.g., a volatile memory device), and storage 510 (e.g., a non-volatile storage area, such as magnetic disk drives, optical disk drives, a tape drive, etc.). An operating system 505 may execute in memory 504. The storage 510 may comprise an internal storage device or an attached or network accessible storage. Computer programs 506 in storage 510 may be loaded into the memory 504 and executed by the processor 502 in a manner known in the art. The architecture further includes a network card 508 to enable communication with a network. An input device 512 is used to provide user input to the processor 502, and may include a keyboard, mouse, pen-stylus, microphone, touch sensitive display screen, or any other activation or input mechanism known in the art. An output device 514 is capable of rendering information transmitted from the processor 502, or other component, such as a display monitor, printer, storage, etc. The computer architecture 500 of the computer systems may include fewer components than illustrated, additional components not illustrated herein, or some combination of the components illustrated and additional components.

The computer architecture 500 may comprise any computing device known in the art, such as a mainframe, server, personal computer, workstation, laptop, handheld computer, telephony device, network appliance, virtualization device, storage controller, etc. Any processor 502 and operating system 505 known in the art may be used.

The foregoing description of implementations of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many implementations of the invention can be made without departing from the spirit and scope of the invention, the invention resides in the claims hereinafter appended.

1. A method for storing data, comprising:
associating a cluster with a plurality of storage groups;
designating a storage group preference order for data sets associated with the cluster; and
when a request to store a data set for the cluster is received, selecting one of the plurality of storage groups using the storage group preference order.

2. The method of claim 1, wherein selecting one of the storage groups further comprises:
selecting one of the storage groups using the storage group preference order and storage space availability in each of the plurality of storage groups.

3. The method of claim 1, further comprising:
providing a preference setting statement for use in designating the storage group preference order.

4. The method of claim 1, further comprising:
presetting a preference setting so that the storage group preference order is used.

5. The method of claim 3, wherein a storage group preference policy includes the preference setting statement.

6. The method of claim 1, further comprising:
storing the data set for the cluster in a storage device in the selected one of the storage groups.

7. The method of claim 1, wherein the data set comprises one of a newly created data set and an extended data set for which storage space is being allocated.

8. The method of claim 1, wherein the storage group comprises a sub storage group.

9. A system for storing data, comprising:
means for associating a cluster with a plurality of storage groups;
means for designating a storage group preference order for data sets associated with the cluster; and
means for when a request to store a data set for the cluster is received, selecting one of the plurality of storage groups using the storage group preference order.

10. The system of claim 9, wherein selecting one of the storage groups further comprises:
means for selecting one of the storage groups using the storage group preference order and storage space availability in each of the plurality of storage groups.

11. The system of claim 9, further comprising:
means for providing a preference setting statement for use in designating the storage group preference order.

12. The system of claim 9, further comprising:
means for presetting a preference setting so that the storage group preference order is used.

13. The system of claim 12, wherein a storage group preference policy includes the preference setting statement.

14. The system of claim 9, further comprising:
means for storing the data set for the cluster in a storage device in the selected one of the storage groups.

15. The system of claim 9, wherein the data set comprises one of a newly created data set and an extended data set for which storage space is being allocated.

16. The system of claim 9, wherein the storage group comprises a sub storage group.

17. An article of manufacture encoded with instructions for storing data, wherein the instructions cause operations to be performed, the operations comprising:
associating a cluster with a plurality of storage groups;
designating a storage group preference order for data sets associated with the cluster; and
when a request to store a data set for the cluster is received, selecting one of the plurality of storage groups using the storage group preference order.

18. The article of manufacture of claim 17, wherein operations for selecting one of the storage groups further comprise:
selecting one of the storage groups using the storage group preference order and storage space availability in each of the plurality of storage groups.

19. The article of manufacture of claim 17, the operations further comprising:
providing a preference setting statement for use in designating the storage group preference order.

20. The article of manufacture of claim 17, the operations further comprising:
presetting a preference setting so that the storage group preference order is used.

21. The article of manufacture of claim 20, wherein a storage group preference policy includes the preference setting statement.

22. The article of manufacture of claim 17, the operations further comprising:
storing the data set for the cluster in a storage device in the selected one of the storage groups.

23. The article of manufacture of claim 17, wherein the data set comprises one of a newly created data set and an extended data set for which storage space is being allocated.

24. The article of manufacture of claim 17, wherein the storage group comprises a sub storage group.
